(19) United States
(12) Patent Application Publication
(10) Pub. No.: US 2017/0370839 A1
(43) Pub. Date: Dec. 28, 2017

(54) COMPONENT TREATMENT PROCESS AND TREATED GAS TURBINE COMPONENT

(71) Applicant: GENERAL ELECTRIC COMPANY, Schenectady, NY (US)

(72) Inventors: Liming ZHANG, II, Greer, SC (US); Yingna WU, Shanghai (CN); Yibo GAO, Shanghai (CN); Robert Trent HULLENDER, Simpsonville, SC (US)

(73) Assignee: GENERAL ELECTRIC COMPANY, Schenectady, NY (US)

(21) Appl. No.: 15/525,664

(22) PCT Filed: Dec. 14, 2015
(86) PCT No.: PCT/CN2015/097239

§ 371 Date: May 10, 2017

(51) Int. Cl. G01N 21/64; G01N 21/71; C23C 10/60; C21D 10/00; G01N 21/65; B23P 6/00

(52) U.S. Cl. CPC G01N 21/6402; C21D 10/00; G01N 21/65; G01N 21/718; C23C 10/60; B23P 6/002; F05D 2230/90

(57) ABSTRACT

A component treatment processes and treated gas turbine components are disclosed. The gas turbine treatment process includes laser-removing coating from a substrate of a turbine component to form laser-induced plasma, spectroscopically analyzing the laser-induced plasma, and discontinuing the laser-removing in response to the spectroscopic analyzing. The treated gas turbine component includes a laser-affected surface, the laser-affected surface having one or both of modified dimensions and modified microstructure due to being exposed to the laser-removing of the coating. The laser-affected surface has a depth corresponding to the laser-removing being discontinued based upon the spectroscopic analyzing of the laser-induced plasma formed from the laser-removing.

### FIELD OF THE INVENTION

The present invention is directed to component treatment processes and treated gas turbine components. More particularly, the present invention is directed to selective laser removal of coatings and/or surfaces of gas turbine components.

### BACKGROUND OF THE INVENTION

Known techniques for removing coatings from turbine components, such as buckets/blades, require chemical solution immersing that is time-consuming. The chemical solutions can induce corrosion for certain materials, thereby limiting the applicability. In addition, such known techniques suffer from limitations regarding accuracy and precision, which can result in large amounts of inefficiencies, leading to higher costs.

### BRIEF DESCRIPTION OF THE INVENTION

In an embodiment, a component treatment process includes laser-removing coating from a substrate of a turbine component to form laser-induced plasma, spectroscopically analyzing the laser-induced plasma, and discontinuing the laser-removing in response to the spectroscopic analyzing.

In another embodiment, a component treatment process includes laser-removing coating from a substrate of a turbine component to form laser-induced plasma by applying a beam from a solid-state laser, the beam having a wavelength of between 380 nm and 1,700 nm and a power density of between 0.01 GW/cm² and 10 GW/cm², spectroscopically analyzing the laser-induced plasma, and discontinuing the laser-removing in response to the spectroscopic analyzing. The spectroscopic analyzing is by atomic emission spectroscopy, fluorescence spectroscopy, Raman spectroscopy, or diffuse reflectance spectroscopy.

In another embodiment, a treated gas turbine component includes a laser-affected surface, the laser-affected surface having one or both of modified dimensions and modified microstructure due to being exposed to laser-removing of a coating. The laser-affected surface has a depth corresponding to the laser-removing being discontinued based upon spectroscopic analyzing of a laser-induced plasma formed by the laser-removing.

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 is a schematic view of a system capable of performing an embodiment of a turbine component treatment process for producing an embodiment of a treated turbine component, according to the disclosure.

### DETAILED DESCRIPTION OF THE INVENTION

Provided are a component treatment process and treated gas turbine component. Embodiments of the present disclosure, for example, in comparison to concepts failing to include one or more of the features disclosed herein, increasing accuracy of coating removal (for example, by greater than 10%, by weight), increasing precision of coating removal (for example, by greater than 5%, by weight), broadening the range of detection limits (for example, increasing from a range of between 1 ppm and 30 ppm to a range of between 1 ppm and 100 ppm, less than 1 ppm, or greater than 100 ppm), or a combination thereof.

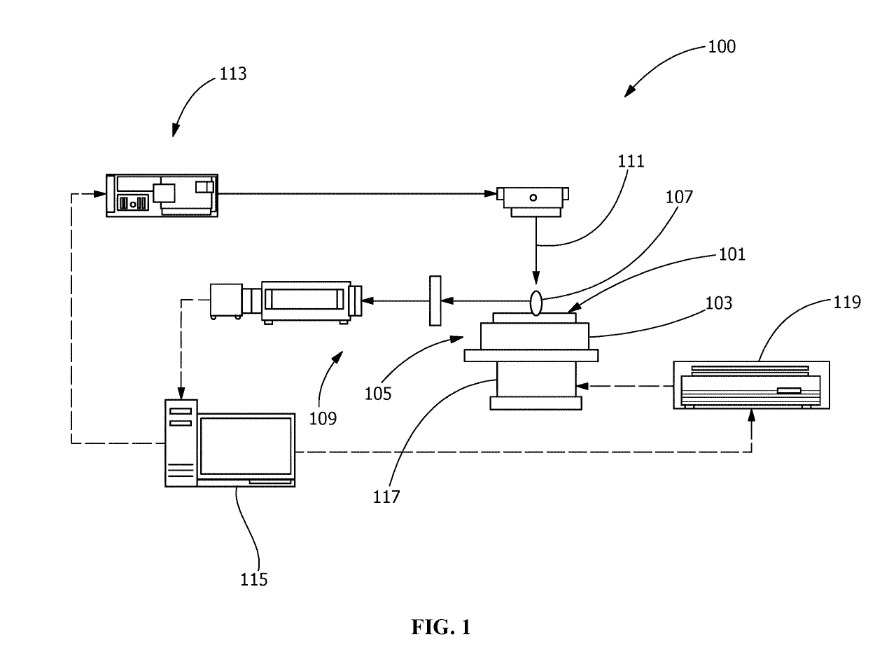

FIG. 1 shows an embodiment of a system 100 for performing a process, according to an embodiment. The process includes laser-removing coating 101 from a substrate 103 of a turbine component 105, for example, a bucket, a blade, a shroud, a dovetail, a hot gas path, or a combination thereof. The coating 101 is an oxide coating, an aluminum coating, a seal coating,

The laser-removing is by any suitable technique, such as, stripping and/or ablating the coating 101. The laser-removing forms laser-induced plasma 107, the presence of which is spectroscopically analyzed/identified. The laser-removing is discontinued in response to the spectroscopic analyzing, for example, through a closed-loop control arrangement operated in conjunction with a computer 115 operably connected to the laser 113 and/or a spectroscopic device 109. In a further embodiment, the laser-removing is performed in conjunction with a movable sub-system 117 (for example, a three-dimensional motion stage) and/or a motion controller 119 operably connected to the computer 115.

The system 100 for performing the process utilizes any laser 113 capable of ablating the coating 101, for example, a solid-state laser (such as, a Nd:YAG laser, a Nd: glass laser, a semiconductor laser, or a diode-pumped solid state laser). In one embodiment, the laser 113 operates within a wavelength, such as, between 380 nm and 1,700 nm, between 380 nm and 1,100 nm, between 380 nm and 700 nm, between 1,000 nm and 1,700 nm, between 1,000 nm and 1,100 nm, between 1,000 nm and 1,050 nm, between 1,050 nm and 1,100 nm, between 1,030 nm, and 1,070 nm, or any suitable combination, sub-combination, range, or sub-range therein.

Additionally or alternatively, in one embodiment, the laser 113 produces a beam 111 having a power density of between 0.01 GW/cm² and 10 GW/cm², 0.01 GW/cm² and 5 GW/cm², 0.01 GW/cm² and 2 GW/cm², 0.01 GW/cm² and 1.5 GW/cm², between 0.5 GW/cm² and 1.5 GW/cm², 0.5 GW/cm² and 1 GW/cm², 1 GW/cm² and 1.5 GW/cm², 0.8 GW/cm² and 1.2 GW/cm², or any suitable combination, sub-combination, range, or sub-range therein.

In one embodiment, the laser-removing includes based applying pulses of a beam having any suitable durations. In one embodiment, the pulses are applied for durations of between 1 ns and 1,000 ns, between 1 ns and 500 ns, between 1 ns and 300 ns, between 100 ns and 300 ns, between 150 ns and 250 ns, between 200 ns and 250 ns, between 150 ns and 200 ns, between 180 ns and 220 ns, between 5 ns and 15 ns, between 10 ns and 15 ns, between 5 ns and 10 ns, between 8 ns and 12 ns, or any suitable combination, sub-combination, range, or sub-range therein.

The spectroscopic analyzing is by any suitable technique capable of analyzing the laser-induced plasma 107. For clarity, the spectroscopic device 109 is shown in FIG. 1. However, those skilled in the art will understand that spectroscopic analyzing is capable of being performed with or without a dedicated device, such as the spectroscopic device 109. Suitable techniques include, but are not limited to, atomic emission spectroscopy, fluorescence spectroscopy, laser-induced fluorescence, Raman spectroscopy, diffuse reflectance spectroscopy, or a combination thereof.

Upon completing the process, in one embodiment, the component 105 becomes a treated gas turbine component. In the treated gas turbine component, a sub-layer of the coating 101 or the substrate is a laser-affected surface. The laser-affected surface has one or both of modified dimensions and modified microstructure due to being exposed to the beam 111 removing of the coating 101. The laser-affected surface has a depth corresponding to the laser-removing being discontinued based upon the spectroscopic analyzing of the laser-induced plasma 107.

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified.

### PARTS LIST

100 System
101 Coating
103 Substrate
105 Component
107 Laser-Induced Plasma
109 Spectroscopic Device
111 Beam
113 Laser
115 Computer
117 Movable Sub-System
119 Controller

What is claimed is:

1. A component treatment process, comprising:
laser-removing coating from a substrate of a turbine component to form laser-induced plasma;
spectroscopically analyzing the laser-induced plasma; and
discontinuing the laser-removing in response to the spectroscopic analyzing.

2. The process of claim 1, wherein the spectroscopic analyzing is by atomic emission spectroscopy.

3. The process of claim 1, wherein the spectroscopic analyzing is by fluorescence spectroscopy.

4. The process of claim 1, wherein the spectroscopic analyzing is by laser-induced fluorescence.

5. The process of claim 1, wherein the spectroscopic analyzing is by Raman spectroscopy.

6. The process of claim 1, wherein the spectroscopic analyzing is by diffuse reflectance spectroscopy.

7. The process of claim 1, wherein the laser-removing is by applying a beam from a solid-state laser.

8. The process of claim 1, wherein the laser-removing is by applying a beam having a wavelength of between 380 nm and 1,700 nm.

9. The process of claim 1, wherein the laser-removing is by applying a beam having a power density of between 0.01 GW/cm² and 10 GW/cm².

10. The process of claim 1, wherein the laser-removing is by applying pulses of a beam, the pulses having a duration of between 1 ns and 1,000 ns.

11. The process of claim 1, wherein the laser-removing is by applying pulses of a beam, the pulses having a duration of between 150 ns and 250 ns.

12. The process of claim 1, wherein the laser-removing is by applying pulses of a beam, the pulses having a duration of between 5 ns and 15 ns.

13. The process of claim 1, wherein the laser-removing is by applying pulses of a beam, the pulses having a duration of between 8 ns and 12 ns.

14. The process of claim 1, wherein the component is a turbine component.

15. The process of claim 14, wherein the turbine component is a bucket.

16. The process of claim 14, wherein the turbine component is a blade.

17. The process of claim 14, wherein the coating is an oxide coating.

18. The process of claim 14, wherein the coating includes aluminum.

19. A gas turbine component treatment process, comprising:
laser-removing coating from a substrate of a turbine component to form laser-induced plasma by applying a beam from a solid-state laser, the beam having a wavelength of between 380 nm and 1,700 nm and a power density of between 0.01 GW/cm² and 10 GW/cm²;
spectroscopically analyzing the laser-induced plasma; and
discontinuing the laser-removing in response to the spectroscopic analyzing;
wherein the spectroscopic analyzing is by atomic emission spectroscopy, fluorescence spectroscopy, Raman spectroscopy, or diffuse reflectance spectroscopy.

20. A treated gas turbine component, comprising:
a laser-affected surface, the laser-affected surface having one or both of modified dimensions and modified microstructure due to being exposed to laser-removing of a coating;
wherein the laser-affected surface has a depth corresponding to the laser-removing being discontinued based upon spectroscopic analyzing of a laser-induced plasma formed by the laser-removing.
